(19) United States
(12) Patent Application Publication
(10) Pub. No.: US 2009/0298419 A1
(43) Pub. Date: Dec. 3, 2009

(54) USER EXCHANGE OF CONTENT VIA WIRELESS TRANSMISSION

(75) Inventors: Deepak P. Ahya, Plantation, FL (US); Daniel A. Baudino, Lake Worth, FL (US)

Correspondence Address: Cuenot, Forsythe & Kim, 12230 FOREST HILL BLVD., SUITE 120, WELLINGTON, FL, 33414, US

(73) Assignee: Motorola, Inc., Schaumburg, IL (US)

(21) Appl. No.: 12/128,497

(22) Filed: May 28, 2008

(51) Int. Cl. H04H 40/00; H04M 1/00

(52) U.S. Cl. 455/3.06; 455/550.1

(57) ABSTRACT

A method (300) of exchanging content (170). On a first mobile station (110), a direction in which a second mobile station (120) is positioned can be determined. The second mobile station can be authenticated. Responsive to receiving a user input that indicates to communicate the content to the second mobile station, the content can be wirelessly transmitted to the second mobile station. A mobile station can include a user interface (204), which may include a display (114). The mobile station also can include a controller (202) that determines a direction in which a second mobile station is positioned and authenticates the second mobile station. Responsive to the user interface receiving a user input that indicates to communicate the content to the second mobile station, a transceiver (224) can wirelessly transmit the content to the second mobile station.

### BACKGROUND OF THE INVENTION

1. Field of the Invention

The present invention generally relates to data communications and, more particularly, to sharing of content between mobile stations.

2. Background of the Invention

The advancement of technology in the electronic arts over the last few decades has triggered the proliferation of personal electronic devices, including electronic devices that are used for mobile communications. Moreover, in recent years various electronic technologies have begun to merge. For instance, personal digital assistants, which not only wirelessly communicate, but also provide a user interface for user interaction with an assortment of computer programs, are now commonplace. Nonetheless, both consumers and businesses continue to demand ever increasing functionality in such devices in order to increase productivity and simplify the interaction between humans and machines.

### SUMMARY OF THE INVENTION

The present invention relates to a method of exchanging content. The method can include, on a first mobile station, determining a direction in which a second mobile station is positioned. Further, the second mobile station can be authenticated. Responsive to receiving a user input that indicates to communicate the content to the second mobile station, the content can be wirelessly transmitted to the second mobile station.

The present invention also relates to a mobile station that includes a user interface, which includes a display. The mobile station also can include a controller that determines a direction in which a second mobile station is positioned and authenticates the second mobile station. The mobile station also can include a transceiver that, responsive to the user interface receiving a user input that indicates to communicate the content to the second mobile station, wirelessly transmits the content to the second mobile station.

Yet another embodiment of the present invention can include a computer program product including a computer-usable medium having computer-usable program code that, when executed, causes a machine to perform the various steps and/or functions described herein.

### BRIEF DESCRIPTION OF THE DRAWINGS

Preferred embodiments of the present invention will be described below in more detail, with reference to the accompanying drawings, in which:

FIG. 1 depicts a communication system that is useful for understanding the present invention;

FIG. 2 depicts a block diagram of a mobile station that is useful for understanding the present invention; and

FIG. 3 is a flowchart that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

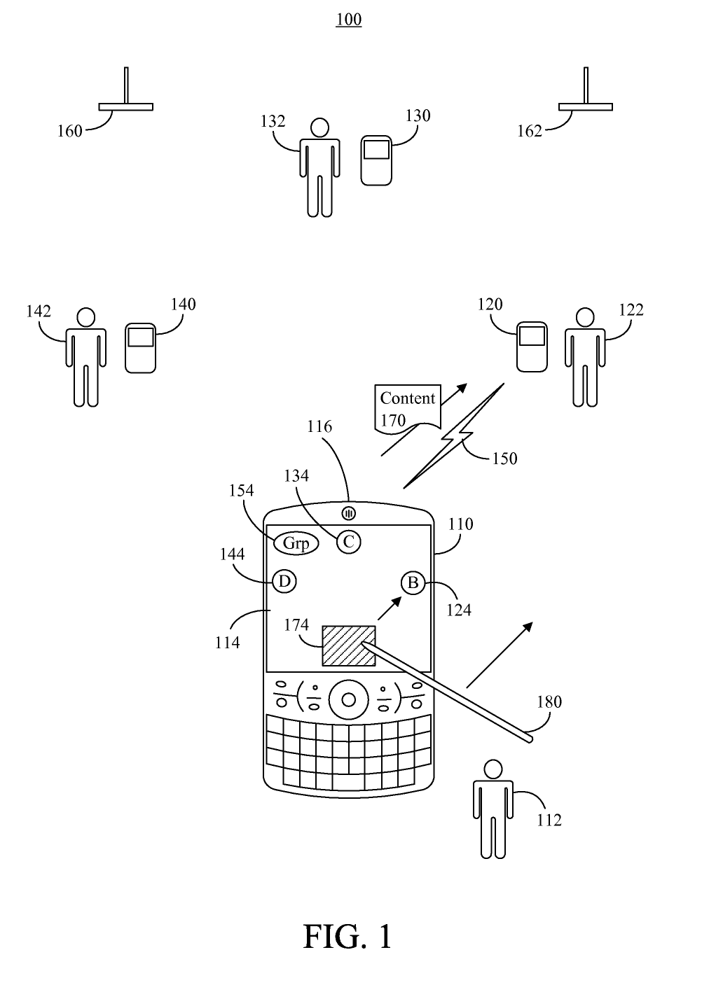

Arrangements described herein relate to supporting the exchange of content between mobile stations in a manner that, for users of the mobile stations, is simple and intuitive. Referring to FIG. 1, an example of a communication system 100 which is useful for understanding these arrangements is presented. The communication system 100 can include a plurality of mobile stations 110, 120, 130, 140. Examples of mobile stations 110-140 can include, but are not limited to, personal digital assistants, mobile computers, mobile terminals, mobile telephones, mobile radios, application specific devices, or the like.

In one arrangement, the mobile stations 110-140 can communicate among each other via direct wireless communication links. As used herein, a direct wireless communication link is a wireless communication link between a first apparatus and at least a second apparatus without an intervening network or repeater. For example, a communication link 150 between the mobile station 110 and the mobile station 120 can be a direct wireless communication link. The direct wireless communication link 150 can be implemented using RF signals, infrared signals, or any other suitable wireless communication signals.

Moreover, the direct wireless communication link 150 can be implemented in accordance with any suitable communication protocol. For example, the direct wireless communication link 150 can be implemented in accordance with a wireless personal area network (PAN) protocol such as IEEE 802.15, Bluetooth or Zigbee. In another example, the direct wireless communication link 150 can be implemented in accordance with a wireless networking protocol, such as 802.11 or 802.16 (WiMAX), even though networking devices external to the mobile stations 110, 120 need not be required.

In another arrangement, the mobile stations 110-140 can communicate among each other via one or more communication networks. Examples of suitable communication networks include, but are not limited to, wide are networks (WANs), local area networks (LANs), wireless LANs (WLANs), mesh networks, metropolitan area networks (MANs), and the like. Any of a variety of suitable communication protocols can be implemented to communicate via the communication network(s), for instance 802.11, 802.16, 3G, 4G, EUTRAN, UMB, WPA, WPA2, GSM, TDMA, CDMA, WCDMA, OFDM, LTE and so on.

By way of example, the mobile stations 110-140 can communicate via one or more access points 160, 162. The access points 160, 162 can be base transceiver stations, repeaters, or access points associated with a WAN, WLAN, MAN or a mesh network. Nonetheless, the invention is not limited in this regard and the access points 160, 162 can be implemented as any other devices or systems that provide one or more of the mobile stations 110-140 access to a suitable communication network.

In operation, the mobile station 110 can detect the presence of one or more of the mobile stations 120, 130, 140 and/or respective users 122, 132, 142 of the mobile stations 120, 130, 140. Presence of the mobile stations 120-140 and/or users 122-142 can be detected by the mobile station 110 in any suitable manner. In an arrangement in which the mobile stations 110-140 communicate via a PAN protocol (e.g. IEEE 802.15, Bluetooth or Zigbee), the mobile station 110 can detect the respective mobile stations 120-140 in accordance with such protocol. For instance, if the mobile stations 110-140 are configured to communicate among one another via Bluetooth, the mobile stations 110-140 can generate inquiries and/or discover inquiries from other devices in accordance with the Bluetooth protocol. If instead the mobile stations 110-140 are configured to communicate among one another via a network, the mobile stations 110-140 can establish network presence and identify other network devices in accordance with the applicable networking protocol.

Further, the mobile station 110 can present a respective identifier 124, 134, 144 associated with each of the mobile stations 120, 130, 140 and/or users 122, 132, 142 that are detected, for instance on a display 114. In addition to, or in lieu of, such identifiers 124-144, one or more identifiers 154 can be presented to represent groups of mobile stations 120-140 and/or users 122-142. The mobile station also can present an identifier 174 associated with content 170 to be communicated. Each of the identifiers 124-174 can comprise text, an icon, an image, a graphic, audio information, video information and/or any other data that may used to identify the mobile stations 120-140, users 122-142, content 170 and/or groups associated with the respective identifiers 124-174.

The identifiers 124-174 can be arranged in any suitable manner. For instance, in one arrangement, the identifiers 124-174 can be arranged on the display 114 according to user preferences. Moreover, the mobile station 110 can be configured to allow the user 112 to manipulate the respective positions of the identifiers 124-174 on the display 114 as desired. In another arrangement, the identifier 174 can be positioned in a default location, and the identifiers 124-144 can be positioned in accordance with an order in which the mobile stations 120-140 are detected, respective priorities of the mobile stations 120-140/users 122-142, names of the users 122-142, etc. In yet another arrangement, the identifiers 124-174 can be positioned according to the respective locations/directions of the mobile stations 120-140 and/or users 122-142 with respect to the mobile station 110 and/or user 112.

The locations/directions of the mobile stations 120-140 and/or users 122-142 can be detected by the mobile station 110 using any of a variety of location/direction identification techniques. In one arrangement, the mobile stations 120-140 can include local positioning systems and/or global positioning systems (GPSs) which indicate their respective locations, and can communicate their respective mobile station identifiers and location coordinates to the mobile station 110. Alternatively, the mobile stations 120-140 can communicate their respective identifiers and location coordinates to another device from which such information may be accessed by the mobile station 110, for instance a network server. Local positioning systems and GPSs are known to those skilled in the art.

In another arrangement, the mobile station 110 can monitor RF signals and/or audio signals to identify the respective mobile stations 120-140 and/or users 122-142 and detect the relative directions in which the mobile stations 120-140/users 122-142 are located. For example, the mobile station 110 can monitor RF signals generated by each of the mobile stations 120-140 and, based on identification information contained in such signals (e.g. header information, or the like) determine from which mobile station 120-140 each RF signal is generated.

The mobile station 110 also can monitor audio signals generated by the respective users 122-142 and, using voice recognition, associate each of the audio signals with a respective user 122-142 from whom it is generated. The audio signals also can be associated with respective mobile stations 120-140 that correspond to the respective users 122-142. If audio signals generated by one or more of the users 122-142 are not recognized by the mobile station 110, the mobile station 110 can prompt the user 112 to enter one or more user inputs that identify such users 122-142 and to associate such users with the detected audio signals.

The direction of the respective mobile stations 120-140/users 122-142 can be determined by monitoring and comparing changes in the receive signal strength of RF signals and/or audio signals that are received from the respective mobile stations 120-140/users 122-142 as axial movement of the mobile station 110 is detected. In such arrangements, the mobile station 110 can include a compass, an accelerometer and/or any other devices with which the mobile station 110 can detect its directional orientation and/or rotation (e.g. axial) movement. Such detection can facilitate determination of whether the mobile station 110 is pointed toward any of the mobile stations 120-140, even if the mobile station 110 has moved.

For example, when receiving RF signals from the mobile stations 120-140, the mobile station 110 can determine the receive signal strength for each of the RF signals and associate the receive signal strength with an indicator of the mobile station 120-140 from which the RF signal is received and a direction the mobile station 110 is pointed when the RF signal was received. Similarly, when receiving audio signals from the users 122-142, the mobile station 110 can determine the receive signal strength for each of the audio signals and associate the receive signal strength with an indicator of the user 122-142 from which the audio signal is received and a direction the mobile station 110 is pointed when the audio signal was received. The direction that the mobile station 110 is pointed when a strongest RF/audio signal strength is detected can correspond to the direction of the mobile station 120-140/user 122-142 from which the RF signals or audio signals are received.

In an arrangement in which the mobile station 110 includes a plurality of antennas for receiving RF signals, or a plurality of input audio transducers, the mobile station 110 can monitor the respective times at which the respective RF signals or audio signals are received. The timing information then can be processed to determine the direction from which the RF signals or audio signals are generated, for example using triangulation, trilateration, or another suitable technique.

For example, if a first instance of a particular RF signal is received by a first antenna at the same time a second instance of the same RF signal is received by a second antenna, this can indicate that the RF signal source (e.g. the mobile station 130) is positioned equidistant from each of the antennas. Thus, if the two antennas are separated by a particular distance along a front side 116 of the mobile station 110, the RF signal source may be positioned directly in front of, or behind, the mobile station 110. In some instances it may be assumed that all such RF sources are located in front of the mobile station 110. If not, timing information identifying when one or more additional antennas receive another instance of the same RF signal can be processed to resolve whether the RF signal source is positioned in front of or behind the mobile station 110. Alternatively, characteristics of the receive signal, such as the signal strength or spectral content, can be processed to make such determination.

Similarly, if two input audio transducers are separated by a particular distance along a front side 116 of the mobile station 110, and at the same time each of the input audio transducers receive a respective instance of the same audio signal, this also can indicate that the audio signal source (e.g. the user 132) is positioned equidistant from each of the input audio transducers, and thus is positioned directly in front of or behind the mobile station 110. Again, if it is not assumed that the audio signal source is located in front of the mobile station 110, timing information indicating when a third input audio transducer receives another instance of the same audio signal or characteristics of the audio signal (e.g. signal strength and/or spectral content of the audio signal) can be processed to determine whether the audio source is positioned in front of or behind the mobile station 110.

Referring again to the processing of RF signals to determine the direction of the mobile stations 120-140 and/or users 122-142, if a first instance of the RF signal is received by a first antenna before a second instance of the same RF signal is received by a second antenna, this would indicate that the RF signal source is closer to the first antenna than to the second antenna. The time delay from when the first instance of the RF signal is received and the second instance of the RF signal is received can be determined. This time delay, as well as an indicator of the physical distance by which the first and second antennas are separated, can be processed to determine the relative direction in which the mobile station 120-140 that generated the RF signal is positioned. Again, additional processing can be implemented as described to determine whether such a device is positioned in front of or behind the mobile station 110.

Similarly, if a first instance of the audio signal is received by a first input audio transducer before a second instance of the same audio signal is received by a second input audio transducer, this would indicate that the audio signal source is closer to the first input audio transducer than to the second input audio transducer. The time delay from when the first instance of the audio signal is received and the second instance of the audio signal is received can be determined. Along with an indicator of the physical distance by which the first and second input audio transducers are separated, the time delay can be processed to determine the relative direction in which the mobile station 120-140 or user 122-142 that generated the audio signal is positioned. As noted, additional processing can be implemented as described to determine whether such a device is positioned in front of or behind the mobile station 110.

In another arrangement, if the mobile stations 110-140 communicate via a communication network, the respective locations of the mobile stations 120-140 can be determined by the mobile stations 120-140 or the communication network using triangulation, trilateration, or any other suitable process. For example, signals generated by the respective mobile stations 120-140 can be detected by a plurality of access points 160, 162 and the respective times at which the access points 160, 162 receive the signals can be monitored. Beam forming techniques also can be implemented by a plurality of the access points 160, 162 to track relative directions of the mobile stations 120-140 with respect to the access points 160, 162. The timing information and/or direction information then can be processed to determine the respective locations of the mobile stations 120-140, for example using techniques previously discussed for determining the relative direction of the RF and audio signal sources.

At some time, a user 112 of the mobile station 110 may elect to communicate the content 170 to one or more of the mobile stations 120-140/users 122-142. For instance, the user 112 may elect to communicate the content 170 to the user 122 of the mobile station 120. The content 170 can comprise any electronic data that may be communicated from the mobile station 110 to another mobile station, such as the mobile station 120. For example, the content 170 can comprise one or more data files, text, audio, video and/or any other information that may be communicated in an electronic format.

To initiate communication of the content 170, the user 112 can enter a user input into the mobile station 110 that indicates to the mobile station 110 to wirelessly transmit the content 170 to the mobile station 120. In response, the mobile station 110 can transmit the content 170 to the mobile station 120 via the direct wireless communication link 150 or via one or more of the access points 160, 162.

The user input can be any suitable user input which indicates the content to be communicated and the user 122/mobile station 120 to which the content 170 is to be communicated. For example, in one arrangement, the user input can be entered via a selection of one or more buttons, keys, soft keys, keypads, touch pads, control surfaces, and/or the like. The user input also can be entered via a spoken utterance that is detected and processed by the mobile station. In another arrangement, the user input can include one or more inputs into the display 114 (e.g. if the display is a touch screen) using a stylus 180 or a user appendage. In yet another arrangement, the user input can be a gesture or motion detected by a motion sensor, such as an infrared detector, a motion detector, an image capture device, or another device which can detect a gesture or motion.

As an example, via the stylus 180 or the appendage, the user 112 can select the identifier 174 associated with the content 170, and move the identifier 174 toward the identifier 124 associated with the mobile station 120 and/or user 122, thereby indicating to the mobile station 110 to wirelessly transmit the content 170 to the mobile station 120. If the user 112 moves the identifier 174 toward the identifier 154 representing a group of mobile stations 120-140 and/or users 122-142, such movement can indicate to the mobile station 110 to wirelessly transmit the content 170 to each mobile station 120-140 associated with the group.

In another example, the user can point a portion of the mobile station 110, for instance the front side 116 of the mobile station 110, toward the mobile station 120-140 and/or user 122-142 to which it is desired to communicate the content 170, and enter a user input to initiate wireless transmission of the content 170 to the desired mobile station 120-140/user 122-142. For instance, if the mobile station 110 is pointed toward the mobile station 120, the mobile station 110 can transmit the content 170 to the mobile station 120. Similarly, if the mobile station 110 is pointed toward user 122, and the mobile station 110 has knowledge that the user 122 is associated with the mobile station 120, the mobile station 110 can transmit the content 170 to the mobile station 120.

In a further example, the identifiers 124-154 need not be presented on the display 114 of the mobile station 110. Rather than moving the identifier 174 associated with the content 170 toward an identifier on the display 114 that represents a mobile station/user, the user 112 can initiate wireless transmission of the content 170 by selecting the identifier 174 and moving the identifier in the general direction of the mobile station 120-140 and/or user 122-142 to which the user 112 desires the content 170 to be communicated.

In one aspect of the inventive arrangements, a tolerance can be defined such that any such mobile station 120-140 and/or user 122-142 must be located within a particular range (e.g. ±20°) of the direction in which the identifier 174 was moved. If multiple stations 120-140/users 122-142 are located within the particular range, the content 170 can be transmitted to all mobile stations 120-140/users 122-142 within the range, to the mobile station 120-140/user 122-142 nearest the direction in which the identifier 174 is moved, or the user 112 can be prompted to enter additional inputs to select the target mobile station 120-140/user 122-142.

In yet another example, in lieu of moving the identifier 174 toward the target mobile station 120-140/user 122-142, the user 112 can point a portion of the mobile station 110 toward the user 122-142 and/or mobile station 120-140 that is the intended recipient of the content 170, and provide a suitable user input, such as any of those previously described, to initiate the content 170 to be wirelessly transmitted to the intended recipient. Moreover, if the content 170 is already presumed to be the subject content to be exchanged (e.g. the content 170 is content that currently has focus), the mobile station 110 can wirelessly transmit the content 170 in response to such input without requiring the identifier 174 to be selected.

In one arrangement, the mobile station 110 can determine in which direction it is pointed using a compass, a local positioning system, a GPS, an accelerometer, or another suitable device or system. In another arrangement, the mobile station 110 need not have knowledge in which direction it is presently pointed, only which mobile station 120-140 and/or user 122-142 currently is positioned most directly in front of the mobile station 110. Such mobile station 120-140 and/or user 122-142 can be detected by the mobile station 110 by processing received RF signals and/or audio signals as previously described.

It should be noted that when, or prior to, transmitting the content 170 to a mobile station, such as the mobile station 120, the mobile station 110 can authenticate the mobile station 120. For example, the mobile station 110 can authenticate the mobile station 120 and/or the user 122 when the mobile station 120 is detected, when the mobile station 110 has received an indication from the user 112 to communicate the content 170 to the mobile station 120, or at any other suitable time. Further, a myriad of suitable authentication schemes are well known in the art, and the invention is not limited in this regard. Additional security and/or user prompts also can be implemented on the mobile station 110 (or within the communication network, if used) to reduce the likelihood of content being accidentally sent to non-intended recipients.

It also should be noted that, for the purpose of clarity, only the identifier 174 associated with the content 170 is depicted in the present example. Nonetheless, a plurality of identifiers that are each associated with respective content may be presented on the display 114, and each of the plurality of identifiers may be selected and moved, or otherwise manipulated, to wirelessly transmit associated content to various mobile stations 120-140/users 122-142 in accordance with processes described herein.

Moreover, multiple identifiers may be simultaneously selected, and wireless transmission of content associated with each of such identifiers can be initiated by manipulating such identifiers together. Thus, a plurality of selected content may be transmitted to a particular mobile station 120-140 or group of mobile stations 120-140 in a manner equivalent to that described herein for the content 170.

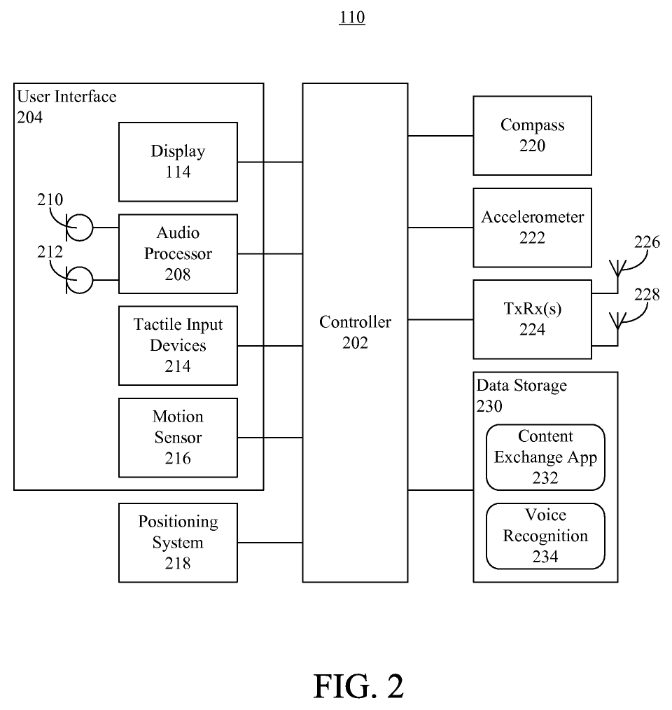

FIG. 2 depicts a block diagram of the mobile station 110 that is useful for understanding the present invention. The mobile station 110 can include a controller 202, which may comprise, for example, one or more central processing units (CPUs), one or more digital signal processors (DSPs), one or more application specific integrated circuits (ASICs), one or more programmable logic devices (PLDs), a plurality of discrete components that can cooperate to process data, and/or any other suitable processing device. In an arrangement in which a plurality of such components are provided, the components can be coupled together to perform various processing functions as described herein.

The mobile station 110 also can include a user interface 204 that receives and detects the user inputs described herein and communicates the user inputs to the controller 202 for further processing. The user interface can comprise the display 114, an audio processor 208, one or more input audio transducers 210, 212, and, optionally, tactile input devices 214 and/or a motion sensor 216. In one arrangement, the display 114 can be a touch screen, though this need not be the case. As known to those skilled in the art, a touch screen is a display that, in addition to presenting visual information, also detects tactile user inputs, for instance via a stylus or an appendage (e.g. finger or thumb).

The audio processor 208 can receive and process audio signals received from one or more input audio transducers (e.g. microphones) 210, 212. For instance, the audio processor 208 can receive input audio signals detected by the input audio transducers 210, 212, perform analog-to-digital conversion on the input audio signals, time stamp or otherwise identify when the input audio signals were received, and so on. The audio processor 208 also can communicate received input audio signals to the controller 202 for further processing.

The input audio signals can be spoken utterances of the mobile station's user. Further, spoken utterances of other users within audible range of the mobile station 110 can be detected by the input audio transducers 210, 212, processed by the audio processor 208, and communicated to the controller 202 for further processing (e.g. to determine the direction in which the other users are located). Such other users can be those audio sources that are associated with other mobile stations. As noted, in an arrangement in which a plurality of input audio transducers 210, 212 are provided, the input audio transducers 210, 212 can be separated by a distance to facilitate determining the direction in which audio signal sources are located.

The audio processor 208 also can receive digital output audio signals, perform analog-to-digital conversion on the output audio signals, and communicate such signals to one or more output audio transducers (not shown). In one arrangement, the audio processor 208 can be a component of the controller 202, though this is not a requirement.

The tactile input devices 214 can comprise one or more buttons, keys, soft keys, keypads, touch pads, control surfaces, and/or the like. In an arrangement in which the display 114 is a touch screen, the tactile input devices 214 need not be required but, optionally, may be provided. Such motion sensors are known to the skilled artisan.

The motion sensor 216 can detect non-tactile user inputs. The motion sensor 216 can comprise, for example, an infrared detector, a motion detector, an image capture device, or another device which can detect a gesture or motion of a user appendage, a stylus, or another suitable user interface tool.

The mobile station 110 also can include a positioning system 218, such as a local positioning system or a GPS, which detects the position of the mobile station 110. The mobile station 110 may exchange positioning information with other mobile stations with which it is communicatively linked. A compass 220 and/or an accelerometer 222 can be provided in addition to, or in lieu of, the positioning system 218. For example, if the mobile station 110 does not receive position information that indicates respective locations of other mobile stations, the compass 220 and/or accelerometer 222 can track orientation and/or rotation movements of the mobile station 110 as part of a process for determining whether the mobile station 110 is pointed toward another mobile station. Data from the positioning system 218, compass 220 and/or an accelerometer 222 can be communicated to the controller 202 for processing.

The mobile station 110 also can include one or more transceivers 224 that communicate via one or more antennas 226, 228. The transceiver(s) 224 can communicate data via IEEE 802 wireless communications, for example, 802.11, 802.15 and 802.16, Bluetooth, Zigbee, 3G, 4G, EUTRAN, UMB, WPA, WPA2, GSM, TDMA, CDMA, WCDMA, OFDM, LTE or any other communications format. Moreover, the transceiver(s) 224 can communicate via direct wireless communication and/or via a communication network.

In an arrangement in which a plurality of antennas 226, 228 are provided, one or more of the antennas 226, 228 can be dedicated to receiving RF signals, though this is not required and each of the antennas also may be dedicated to both transmit and receive RF signals. As noted, in an arrangement in which a plurality of antennas 226, 228 are provided, the antennas 226, 228 can be separated by a distance to facilitate determining the direction in which RF signal sources are located.

The mobile station 110 further can include a data storage 230. The data storage 230 can include one or more storage devices, each of which may include, but is not limited to, a magnetic storage medium, an electronic storage medium, an optical storage medium, a magneto-optical storage medium, and/or any other storage medium suitable for storing digital information. In one arrangement, the data storage 230 can be integrated into the controller 202, though this need not be the case.

A content exchange application 232 and a voice recognition application 234 can be stored on the data storage 230 or otherwise made accessible to the controller 202. The content exchange application 232 can be executed by the controller 202 to implement the methods and processes described herein that are performed by the mobile station 110. For example, the controller 202 can execute the content exchange application 232 to determine the location of other mobile stations and wirelessly transmit content to other mobile stations. For instance, the controller 202 can execute the content exchange application 232 to process location information to determine relative locations of other mobile stations, process input audio signals received via the input audio transducers 210, 212 and/or RF signals received via the antennas 226, 228 to determine relative directions of other mobile stations. The controller 202 also can process user inputs received via the user interface 204 to wirelessly transmit, via the transceiver 224, content to other mobile stations in accordance with the user inputs, and so on.

The voice recognition application 234 can be executed by the controller 202 to process input audio signals so as to identify users who generate the input audio signals, indicate when input audio signals do not correspond to known users, receive spoken utterances as user inputs, and so on. Voice recognition is well known in the art.

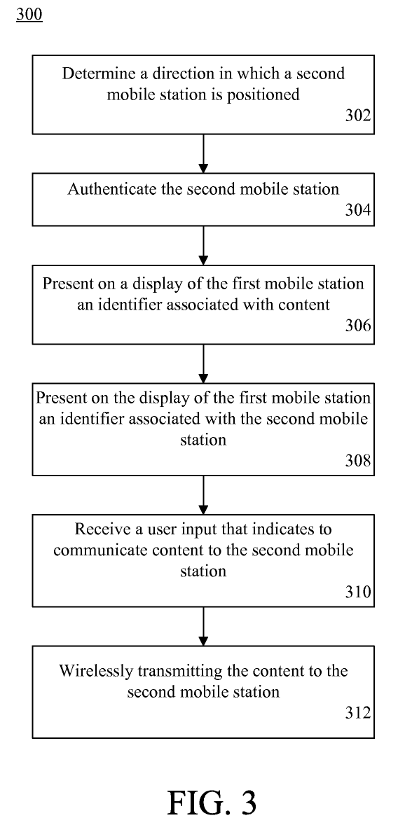

FIG. 3 is a flowchart presenting a method 300 that is useful for understanding the present invention. The method 300 can begin in a state in which a first mobile station is activated and ready to communicate with one or more other mobile stations via direct wireless communication or via one or more communication networks.

At step 302, a direction in which a second mobile station is positioned can be determined. For example, an audio signal associated with the second mobile station can be received and processed. The audio signal can be received via at least two input audio transducers, and a time delay from when a first instance of the audio signal is received and when a second instance of the audio signal is received can be determined.

In another example, at least a first RF signal generated by the second mobile station can be received and processed. In one arrangement, the first RF signal can be received via at least two antennas, and a time delay from when a first instance of the first RF signal is received and when a second instance of the first RF signal is received can be determined. In another arrangement, an axial movement of the first mobile station can be detected. At least a second RF signal generated by the second mobile station can be received, and a signal strength of the first RF signal can be compared with a signal strength of at least the second RF signal.

In yet another arrangement, the direction in which the second mobile station is positioned can be determined by receiving local positioning coordinates or global positioning coordinates corresponding to a relative location of the second mobile station.

At step 304, the second mobile station can be authenticated. At step 306, an identifier associated with content can be presented on a display of the first mobile station. Optionally, at step 308, an identifier associated with the second mobile station can be presented on the display of the first mobile station.

At step 310, a user input can be received that indicates to communicate content to the second mobile station. In one arrangement, the user input can associate the content with the identifier that is associated with the second mobile station. For example, a user selection of the identifier representing the content can be received, and movement on the display of that identifier toward the identifier associated with the second mobile station can be detected.

In another arrangement, receiving the user input that indicates to communicate the content to the second mobile station can include detecting the identifier representing the content being moved toward the determined direction in which the second mobile station is positioned.

In yet another arrangement, receiving the user input that indicates to communicate the content to the second mobile station can include detecting a selection of the identifier representing the content with an appendage or stylus, and detecting the appendage or stylus being moved toward the determined direction in which the second mobile station is positioned.

Proceeding to step 312, the content can be wirelessly transmitted to the second mobile station, for instance via direct wireless communication or via a communication network.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in a program storage device readable by a machine, tangibly embodying a program of instructions executable by the machine to perform methods and processes described herein. The present invention also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a script, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language).

Moreover, as used herein, ordinal terms (e.g. first, second, third, fourth, fifth, sixth, seventh, eighth, ninth, tenth, and so on) distinguish one message, signal, item, object, device, system, apparatus, step, process, or the like from another message, signal, item, object, device, system, apparatus, step, process, or the like. Thus, an ordinal term used herein need not indicate a specific position in an ordinal series. For example, a process identified as a “second process” may occur before a process identified as a “first process.” Further, one or more processes may occur between a first process and a second process.

This invention can be embodied in other forms without departing from the spirit or essential attributes thereof. Accordingly, reference should be made to the following claims, rather than to the foregoing specification, as indicating the scope of the invention.

What is claimed is:

1. A method of exchanging content, comprising:
on a first mobile station, determining a direction in which a second mobile station is positioned;
authenticating the second mobile station; and
responsive to receiving a user input that indicates to communicate the content to the second mobile station, wirelessly transmitting the content to the second mobile station.

2. The method of claim 1, wherein determining the direction in which the second mobile station is positioned comprises:
receiving an audio signal associated with the second mobile station; and
processing the audio signal.

3. The method of claim 2, wherein determining the direction in which the second mobile station is positioned further comprises:
receiving the audio signal via at least two input audio transducers; and
determining a time delay from when a first instance of the audio signal is received and when a second instance of the audio signal is received.

4. The method of claim 1, wherein determining the direction in which the second mobile station is positioned comprises:
receiving at least a first RF signal generated by the second mobile station; and
processing the first RF signal.

5. The method of claim 4, wherein determining the direction in which the second mobile station is positioned further comprises:
receiving the first RF signal via at least two antennas; and
determining a time delay from when a first instance of the first RF signal is received and when a second instance of the first RF signal is received.

6. The method of claim 4, wherein determining the direction in which the second mobile station is positioned further comprises:
detecting an axial movement of the first mobile station;
receiving at least a second RF signal generated by the second mobile station; and
comparing a signal strength of the first RF signal with a signal strength of at least the second RF signal.

7. The method of claim 1, wherein determining the direction in which the second mobile station is positioned comprises:
receiving local positioning coordinates or global positioning coordinates corresponding to a relative location of the second mobile station.

8. The method of claim 1, further comprising:
presenting an identifier associated with the second mobile station on a display of the first mobile station;
wherein receiving the user input that indicates to communicate the content to the second mobile station comprises:
receiving a user input that associates the content with the identifier associated with the second mobile station.

9. The method of claim 8, further comprising:
presenting an identifier associated with the content on the display of the first mobile station;
wherein receiving the user input that associates the content with the identifier associated with the second mobile station comprises:
receiving a user selection of the identifier representing the content; and
detecting the identifier representing the content being moved on the display toward the identifier associated with the second mobile station.

10. The method of claim 1, further comprising:
presenting an identifier associated with the content on a display of the first mobile station;
wherein receiving the user input that indicates to communicate the content to the second mobile station comprises:
detecting the identifier representing the content being moved toward the determined direction in which the second mobile station is positioned.

11. The method of claim 1, further comprising:
presenting an identifier associated with the content on a display of the first mobile station;
wherein receiving the user input that indicates to communicate the content to the second mobile station comprises:
detecting a selection of the identifier representing the content with an appendage or stylus; and
detecting the appendage or stylus being moved toward the determined direction in which the second mobile station is positioned.

12. A mobile station, comprising:
a user interface comprising a display;
a controller that determines a direction in which a second mobile station is positioned and authenticates the second mobile station; and
a transceiver that, responsive to the user interface receiving a user input that indicates to communicate the content to the second mobile station, wirelessly transmits the content to the second mobile station.

13. The mobile station of claim 12, further comprising:
at least one input audio transducer that receives an audio signal associated with the second mobile station;
wherein the controller determines the direction in which the second mobile station is positioned by processing the audio signal.

14. The mobile station of claim 12, wherein:
the transceiver receives at least a first RF signal generated by the second mobile station; and
the controller processes the first RF signal to determine the direction in which the second mobile station is positioned.

15. The mobile station of claim 12, wherein:
the user interface presents an identifier associated with the second mobile station on the display of the first mobile station and receives a user input that associates the content with the identifier as an indication to communicate the content to the second mobile station.

16. The mobile station of claim 15, wherein:
the user interface presents an identifier associated with the content on the display and receives a user selection of the identifier representing the content; and
via the user interface, the controller detects the identifier representing the content being moved on the display toward the identifier associated with the second mobile station.

17. The mobile station of claim 12, wherein:
the user interface presents an identifier associated with the content on the display; and
via the display, the controller detects the identifier representing the content being moved toward the determined direction in which the second mobile station is positioned.

18. The mobile station of claim 12, wherein:
the user interface presents an identifier associated with the content on the display and detects a selection of the identifier representing the content with an appendage or stylus; and
via the display, the controller detects the appendage or stylus being moved toward the determined direction in which the second mobile station is positioned.

19. A computer program product comprising:
a computer-usable medium comprising computer-usable program code that exchanges content, the computer-usable medium comprising:
computer-usable program code that, on a first mobile station, determines a direction in which a second mobile station is positioned;
computer-usable program code that authenticates the second mobile station; and
computer-usable program code that, responsive to receiving a user input that indicates to communicate the content to the second mobile station, wirelessly transmits the content to the second mobile station.

20. The computer program product of claim 19, the computer-usable medium further comprising:
computer-usable program code that presents an identifier associated with the content on the display of the first mobile station;
wherein the computer-usable program code that receives the user input that indicates to communicate the content to the second mobile station comprises:
computer-usable program code that detects the identifier representing the content being moved on the display toward an identifier associated with the second mobile station.
